(19) United States
(12) Patent Application Publication
(10) Pub. No.: US 2019/0381837 A1
(43) Pub. Date: Dec. 19, 2019

(54) MULTIPLANE INTERLOCKING STRUCTURE FOR A TREAD OF A TIRE

(71) Applicant: The Goodyear Tire & Rubber Company, Akron, OH (US)

(72) Inventors: Max Harold Dixon, Kent, OH (US); Samin Askarian, Irvine, CA (US); Joel Joseph Lazeration, Copley, OH (US); Padmarajaiah Saligrama Karidevaiah, Copley, OH (US); Tosh Michael Lloyd, Canton, OH (US); Ahmad Shafiq Bani Hani, Peninsula, OH (US)

(21) Appl. No.: 16/007,148

(22) Filed: Jun. 13, 2018

(51) Int. Cl. B60C 11/12; B60C 11/03; B60C 11/13

(52) U.S. Cl. CPC B60C 11/1218; B60C 11/0306; B60C 2011/1213; B60C 11/1369; B60C 11/1236

(57) ABSTRACT

A tread for a tire includes a plurality of circumferential ribs, at least one of the ribs having sipes extending in a zigzag manner as the sipes extend axially across the rib and also extending in a zigzag manner as the sipes project radially inward from a radially outer surface of the rib.

### FIELD OF INVENTION

The present invention relates to a tire, and more specifically, to a tread for a tire.

### BACKGROUND OF THE INVENTION

A construction may be adopted in conventional pneumatic tires in which, when a cross-section is viewed from a tire meridian direction, a contact patch of a shoulder rib arches and forms a convex on an inner side of a tire radial direction. Due to this construction, contact pressure of the tire may be distributed evenly over a center region and a shoulder region of a tread portion and uneven wear of the tire may be suppressed.

### SUMMARY OF THE INVENTION

A tread for a tire, in accordance with the present invention, includes a plurality of circumferential ribs, at least one of the ribs having sipes extending in a zigzag manner as the sipes extend axially across the rib and also extending in a zigzag manner as the sipes project radially inward from a radially outer surface of the rib.

According to another aspect of the tread, the sipes further include a curved, cylindrical radially innermost surfaces to mitigate cracking and to increase circumferential flexibility of the tread.

According to still another aspect of the tread, the plurality of ribs further includes a first circumferential central rib, a second circumferential intermediate rib, a third circumferential intermediate rib, a fourth circumferential shoulder rib and a fifth circumferential shoulder rib.

According to yet another aspect of the tread, only the fourth and fifth ribs have the sipes.

According to still another aspect of the tread, only the first rib has the sipes.

According to yet another aspect of the tread, only the second and third ribs have the sipes.

According to still another aspect of the tread, only the first and fifth ribs have the sipes.

According to yet another aspect of the tread, each of the first, second, third, fourth, and fifth ribs have the sipes.

According to still another aspect of the tread, only the first and second ribs haves the sipes.

According to yet another aspect of the tread, sipes of the fourth and fifth ribs terminate in notches.

A first tire in accordance with the present invention includes a tread having a plurality of circumferential ribs, at least one of the ribs having sipes extending in a zigzag manner in both axial and radial directions of the tire.

According to another aspect of the first tire, the sipes further include a curved, cylindrical radially innermost surfaces to mitigate cracking and to increase circumferential flexibility of the tread.

According to yet another aspect of the first tire, the plurality of ribs further includes a first circumferential central rib, a second circumferential intermediate rib and a third circumferential shoulder rib.

According to still another aspect of the first tire, only the first and second ribs have the sipes.

According to yet another aspect of the first tire, only the first rib has the sipes.

According to still another aspect of the first tire, only the second and third ribs have the sipes.

According to yet another aspect of the first tire, only the first and third ribs have the sipes.

According to still another aspect of the first tire, each of the first, second, and third ribs have the sipes.

A second tire in accordance with the present invention includes a tread having a plurality of circumferential ribs, each of the ribs having doubly corrugated sipes extending in a zigzag manner in both axial and radial directions of the tire.

According to another aspect of the second tire, the sipes further include a cylindrical, radially innermost surface.

### DEFINITIONS

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane EP of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The present invention will be better understood through reference to the following description and the appended drawings, in which:

FIG. 1 is a schematic orthogonal view of a tire in accordance with the present invention.

FIG. 2 is a schematic detailed orthogonal view of the tread of the tire of FIG. 1.

FIG. 3 is a schematic perspective view of part of the tread of FIG. 2.

FIG. 4 is a schematic perspective view of a blade structure for forming part of the tread of FIGS. 1 through 3.

FIG. 5 is a schematic section view taken along line 5-5 in FIG. 3.

FIG. 6 is a schematic section view taken along line 6-6 in FIG. 3.

### DETAILED DESCRIPTION OF EXAMPLES OF THE INVENTION

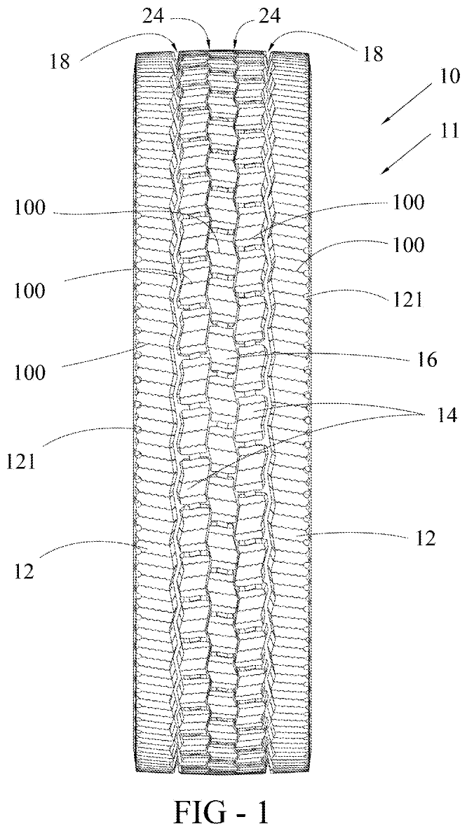

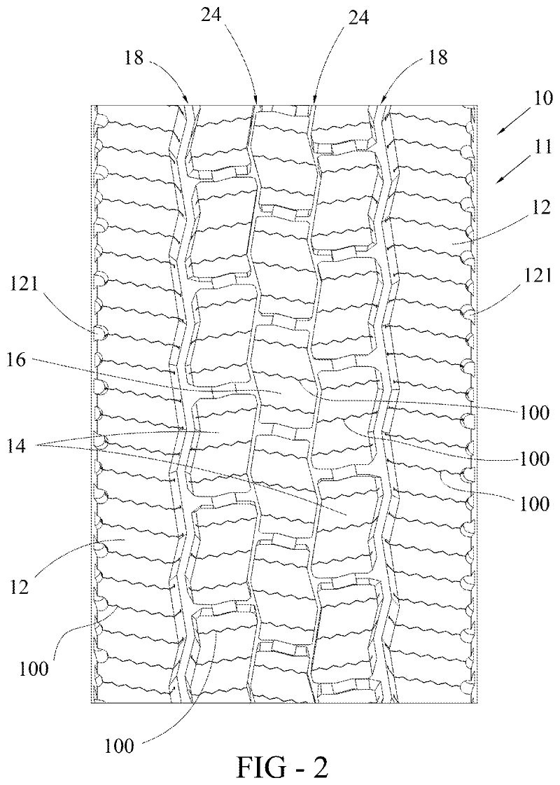

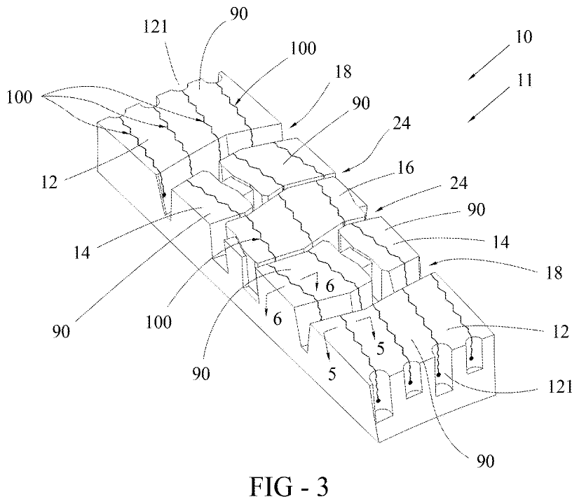

Referring now in more detail to the drawings, the present invention will below be described in more detail. The pneumatic, or non-pneumatic, tire 10 illustrated in FIGS. 1 through 3 may have a tread 11 with a center circumferential rib 16, two intermediate circumferential ribs 14, and two shoulder ribs 12. The five ribs 12, 14, 16 may be defined by two shoulder grooves 18 and two central circumferential grooves 24. The two central circumferential grooves 24 may each have a jagged, or zigzag, cross-section with radially vertical walls and a flat bottom (FIGS. 2 and 3). The two shoulder grooves 18 may be axially wider than the central circumferential grooves 24 and each have a jagged, or zigzag, cross-section with slanted walls and a flat bottom (FIGS. 2 and 3).

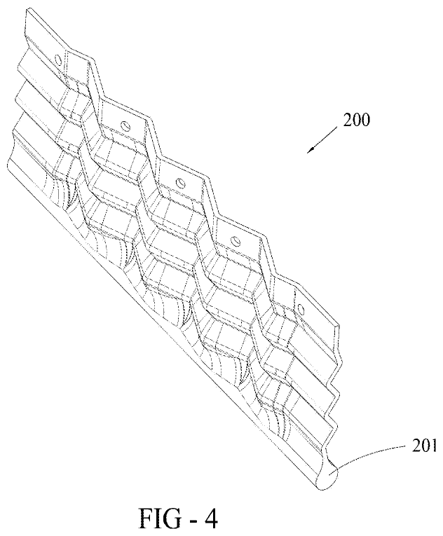

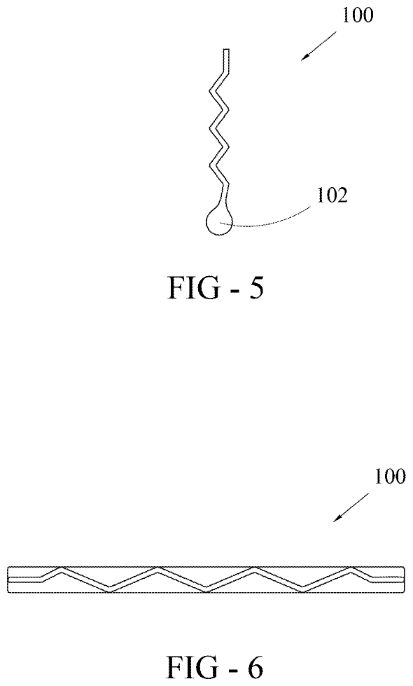

In accordance with the present invention, any and/or all of the ribs 12, 14, 16 may have laterally and circumferentially extending, or slanted, sipes 100. Each of these sipes 100 may extend in a zigzag manner both as the sipes extend axially across the ribs (FIG. 6) and radially inward from the tread surface (FIG. 5). These multiplanar sipes 100 may have curved, cylindrical radially innermost surfaces 101 to mitigate cracking and to increase circumferential flexibility of the tread 11 (FIGS. 5 and 6). FIG. 4 shows an example blade 200 for molding/shaping one of the sipes 100. The blade 200 demonstrates how the varying zigzag surfaces blend into each other, as well as a corresponding radially innermost cylindrical protrusion 201 for forming the surfaces 101 of the sipes 100.

The “double corrugation” or multiplanar configuration created by the zigzag directions in two planes (axially and radially) of the sipes 100 of the present invention may create a locking effect of the side surfaces 103 of the sipes thereby improving stiffness of associated blocks 90 of the ribs 12, 14, 16. This may reduce irregular wear and reduce stress at the radially innermost bottom surfaces 101 of the sipes 100. As shown in FIGS. 1 through 3, the sipes 100 of the shoulder ribs 12 may terminate at radial notches 121 in outer lateral surfaces of the tread 11.

While the present invention has been described in connection with what is considered the most practical and preferred example, it is to be understood that the present invention is not to be limited to these described examples, but is intended to cover various arrangements which are included within the spirit and scope of the broadest possible interpretation of the appended claims so as to encompass all modifications and equivalent arrangements which are possible.

What is claimed:

1. A tread for a tire comprising:
a plurality of circumferential ribs, at least one of the ribs having sipes extending in a zigzag manner as the sipes extend axially across the rib and also extending in a zigzag manner as the sipes project radially inward from a radially outer surface of the rib.

2. The tread as set forth in claim 1 wherein the sipes further include a curved, cylindrical radially innermost surfaces to mitigate cracking and to increase circumferential flexibility of the tread.

3. The tread as set forth in claim 1 wherein the plurality of ribs further includes a first circumferential central rib, a second circumferential intermediate rib, a third circumferential intermediate rib, a fourth circumferential shoulder rib and a fifth circumferential shoulder rib.

4. The tread as set forth in claim 3 wherein only the fourth and fifth ribs have the sipes.

5. The tread as set forth in claim 3 wherein only the first rib has the sipes.

6. The tread as set forth in claim 3 wherein only the second and third ribs have the sipes.

7. The tread as set forth in claim 3 wherein only the first and fifth ribs have the sipes.

8. The tread as set forth in claim 3 wherein each of the first, second, third, fourth and fifth ribs have the sipes.

9. The tread as set forth in claim 3 wherein only the first and second ribs haves the sipes.

10. The tread as set forth in claim 1 wherein sipes of the fourth and fifth ribs terminate in notches.

11. A tire comprising:
a tread having a plurality of circumferential ribs, at least one of the ribs having sipes extending in a zigzag manner in both axial and radial directions of the tire.

12. The tire as set forth in claim 11 wherein the sipes further include a curved, cylindrical radially innermost surfaces to mitigate cracking and to increase circumferential flexibility of the tread.

13. The tire as set forth in claim 11 wherein the plurality of ribs further includes a first circumferential central rib, a second circumferential intermediate rib, and a third circumferential shoulder rib.

14. The tire as set forth in claim 13 wherein only the first and second ribs have the sipes.

15. The tire as set forth in claim 13 wherein only the first rib has the sipes.

16. The tire as set forth in claim 13 wherein only the second and third ribs have the sipes.

17. The tire as set forth in claim 13 wherein only the first and third ribs have the sipes.

18. The tire as set forth in claim 13 wherein each of the first, second, and third ribs have the sipes.

19. A tire comprising:
a tread having a plurality of circumferential ribs, each of the ribs having doubly corrugated sipes extending in a zigzag manner in both axial and radial directions of the tire.

20. The tire as set forth in claim 19 wherein the sipes further include a cylindrical, radially innermost surface.
